(19) United States
(12) Patent Application Publication
(10) Pub. No.: US 2021/0405954 A1
(43) Pub. Date: Dec. 30, 2021

(54) COMPOSITE DISPLAY SCREEN, COMPOSITE DISPLAY SCREEN MODULE, AND DISPLAY CONTROL METHOD THEREOF

(71) Applicant: WUHAN CHINA STAR OPTOELECTRONICS TECHNOLOGY CO., LTD., Wuhan (CN)

(72) Inventors: Renpeng Li, Wuhan (CN); Feng Liu, Wuhan (CN)

(73) Assignee: WUHAN CHINA STAR OPTOELECTRONICS TECHNOLOGY CO., LTD., Wuhan (CN)

(21) Appl. No.: 16/754,025

(22) PCT Filed: Dec. 18, 2019
(86) PCT No.: PCT/CN2019/126135

§ 371 Date: Apr. 6, 2020

(30) Foreign Application Priority Data
Nov. 29, 2019 (CN) 201911200038.2

(51) Int. Cl. G06F 3/14; G09G 3/20; G09G 5/377

(52) U.S. Cl. CPC G06F 3/1431; G09G 3/20; G09G 2370/22; G09G 2340/12; G09G 5/377

(57) ABSTRACT

A composite display screen, a composite display screen module, and a display control method thereof are provided. The composite display screen includes a main display screen corresponding to a main display area and electrically connected to a first display driver integrated circuit; and at least one sub-display screen corresponding to a sub-display area and electrically connected to a second display driver integrated circuit, wherein the sub-display area is disposed on an upper part or/and a lower part of the composite display screen, and a plurality of functional components are disposed correspondingly in the sub-display area. A first pixel unit in the main display area includes a first sub-pixel unit and a first transparent subunit, a second pixel unit of the sub-display screen comprises a second sub-pixel unit and a second transparent subunit, and an area of the second transparent subunit is greater than an area of the first transparent subunit.

### FIELD OF INVENTION

The present disclosure relates to the field of display technologies, and more particularly, to a composite display screen, a composite display screen module, and a display control method thereof.

### BACKGROUND OF INVENTION

As the new generation of display technologies, organic light-emitting diodes (OLEDs) have wider color gamut and faster response times. They can also be made lighter and thinner in terms of thicknesses. With full screens becoming more popular, how to increase the screen ratio becomes an important problem. A free-form cutting method is used to process panels in current technology to avoid cameras, infrared holes, and fingerprint areas. Although the screen ratio has been greatly improved by a free-form cut screen, devices on a motherboard of a mobile phone, such as cameras, still cannot be avoided, thereby causing a certain loss of the screen ratio.

Therefore, how to improve the screen ratio and to achieve a full screen display is the problem to be solved in the present disclosure.

Technical problem: a free-form cutting method is used to process panels in current technology to avoid cameras, infrared holes, and fingerprint areas. Although the screen ratio has been greatly improved by a free-form cut screen, devices on a motherboard of a mobile phone, such as cameras, still cannot be avoided, thereby causing a certain loss of the screen ratio.

Therefore, how to improve the screen ratio and to achieve a full screen display is the problem to be solved in the present disclosure.

### SUMMARY OF INVENTION

To solve the above technical problem, an objective of the present disclosure is to provide a composite display screen, a composite display screen module including the composite display screen, and a display control method thereof, to improve the screen ratio and achieve a full screen display.

To achieve the above objective, an embodiment of the present disclosure provides a composite display screen.

The composite display screen comprises:

a main display screen corresponding to a main display area and electrically connected to a first display driver integrated circuit; and at least one sub-display screen corresponding to a sub-display area and electrically connected to a second display driver integrated circuit, wherein the sub-display area is disposed on an upper part or/and a lower part of the composite display screen, and a plurality of functional components are disposed correspondingly in the sub-display area.

In an embodiment of the present disclosure, wherein a first pixel unit in the main display area comprises a first sub-pixel unit and a first transparent subunit, a second pixel unit of the sub-display screen comprises a second sub-pixel unit and a second transparent subunit, and an area of the second transparent subunit is greater than an area of the first transparent subunit.

In an embodiment of the present disclosure, wherein the sub-display screen is a first sub-display screen corresponding to a first sub-display area and electrically connected to the second display driver integrated circuit, wherein the first sub-display area is disposed on the upper part of the composite display screen.

In an embodiment of the present disclosure, the composite display screen further comprises a second sub-display screen corresponding to a second sub-display area and electrically connected to the second display driver integrated circuit, wherein the second sub-display area is disposed on the lower part of the composite display screen.

To achieve the above objective, the present disclosure further provides a composite display screen module. The composite display screen module comprises: the above composite display screen; an input unit connected to a touch control sensor, and used to generate an image signal in response to a user's input operation; and an image processing unit connected to the input unit, and used to divide a received image signal into a first part and a second part, wherein the first part corresponds to the main display area, and the second part corresponds to the sub-display area, wherein the sub-display screen of the composite display screen is a first sub-display screen corresponding to a first sub-display area and electrically connected to the second display driver integrated circuit, wherein the first sub-display area is disposed on the upper part of the composite display screen.

In an embodiment of the present disclosure, wherein the sub-display screen of the composite display screen is a first sub-display screen corresponding to a first sub-display area and electrically connected to the second display driver integrated circuit, wherein the first sub-display area is disposed on the upper part of the composite display screen.

In an embodiment of the present disclosure, the composite display screen further comprises a second sub-display screen corresponding to a second sub-display area and electrically connected to the second display driver integrated circuit, wherein the second sub-display area is disposed on the lower part of the composite display screen.

To achieve the above objective, the present disclosure further provides a display control method of the above composite display screen module. The method comprises following steps:

S1) the input unit transmitting the image signal to the image processing unit; and

S2) the image processing unit dividing the received image signal into the first part and the second part, wherein the first part corresponds to the main display area, and the second part corresponds to the sub-display area.

Further, the method comprises following steps:

S3) the image processing unit detecting whether devices in the sub-display area are turned on; and

S4) the image processing unit controlling the first display driver integrated circuit and the second display driver integrated circuit to modulate whether to display images in the main display area and the sub-display area.

In an embodiment of the present disclosure, wherein the step S4) further comprises following steps: S5) if the devices in the sub-display area are detected to be turned on, the image processing unit will control the first display driver integrated circuit to be turned on and the second display driver integrated circuit to be turned off.

In an embodiment of the present disclosure, wherein the step S5) further comprises following steps: S6) making the image signal of the first part displayed in the main display area and the image signal of the second part not displayed.

In an embodiment of the present disclosure, wherein the step S4) further comprises following steps: S7) if the devices in the sub-display area are detected to be turned off, the image processing unit will control the first display driver integrated circuit and the second display driver integrated circuit to be turned on.

In an embodiment of the present disclosure, wherein the step S7) further comprises following steps: S8) making the image signal of the first part displayed in the main display area and the image signal of the second part displayed in the sub-display area.

Beneficial effect: the present disclosure divides a display screen into a main display screen and a sub-display screen which are correspondingly connected to a first display driver integrated circuit and a second display driver integrated circuit, thereby controlling a main display area and a sub-display area to display images respectively. That is, the second display driver integrated circuit controls the images displayed or not displayed in the sub-display area according to a status of functional components, thereby achieving a full screen display, improving the screen ratio, and providing a better visual experience for users. Further, making an area of a transparent area of the second pixel unit of the sub-display screen greater than an area of a transparent area of the first pixel unit of the main display screen improves transmittance and transparency in the sub-display area, thereby making functional components work normally.

### DESCRIPTION OF DRAWINGS

FIG. 1 is a schematic diagram of division of a composite display screen according to an embodiment of the present disclosure.

FIG. 2 is a partial schematic structural diagram of a composite display screen module according to an embodiment of the present disclosure.

FIG. 3 is an image processing flowchart of a display control method of a composite display screen module according to an embodiment of the present disclosure.

FIG. 4 is an image displaying flowchart of a display control method of a composite display screen module according to an embodiment of the present disclosure.

### DETAILED DESCRIPTION OF PREFERRED EMBODIMENTS

In order to make the above and other objects, features, and advantages of the present disclosure more comprehensible, the following describes preferred embodiments of the present disclosure and the accompanying drawings for detailed descriptions. In the description of the present disclosure, it should be understood that terms such as “upper”, “lower”, “front”, “rear”, “left”, “right”, as well as derivative thereof should be construed to refer to the orientation as described or as shown in the drawings under discussion. These relative terms are for convenience of description, do not require that the present disclosure be constructed or operated in a particular orientation, and shall not be construed as causing limitations to the present disclosure. The identical or similar reference numerals constantly denote the identical or similar elements or elements having the identical or similar functions in the drawings.

A composite display screen provided by the present disclosure comprises: a main display screen corresponding to a main display area 1 and electrically connected to a first display driver integrated circuit 4; and at least one sub-display screen corresponding to a sub-display area and electrically connected to a second display driver integrated circuit 5, wherein the sub-display area is disposed on an upper part or/and a lower part of the composite display screen, and a plurality of functional components are disposed correspondingly in the sub-display area. Wherein, a first pixel unit in the main display area comprises a first sub-pixel unit and a first transparent subunit, a second pixel unit of the sub-display screen comprises a second sub-pixel unit and a second transparent subunit, and an area of the second transparent subunit is greater than an area of the first transparent subunit.

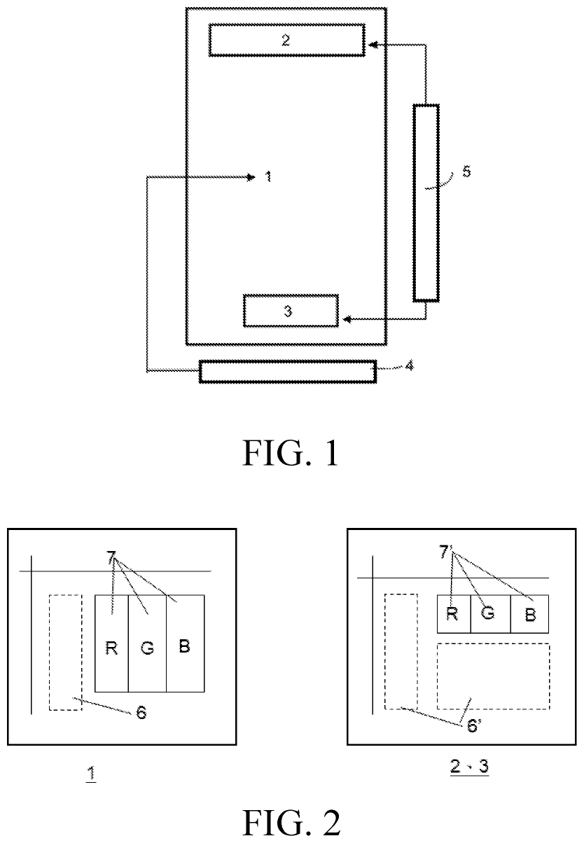

Referring to FIG. 1, FIG. 1 is a schematic diagram of division of a composite display screen according to an embodiment of the present disclosure.

As shown in FIG. 1, the composite display screen of the present disclosure comprises a main display screen, a first sub-display screen, and a second sub-display screen. Wherein, the main display screen corresponds to the main display area 1, and is electrically connected to the first display driver integrated circuit 4. The first sub-display screen corresponds to a first sub-display area 2, and is electrically connected to the second display driver integrated circuit 5, wherein the first sub-display area 2 is disposed on the upper part of the composite display screen. The second sub-display screen corresponds to a second sub-display area 3, and is electrically connected to the second display driver integrated circuit 5, wherein the second sub-display area 3 is disposed on the lower part of the composite display screen. It should be noted that the main display area 1 is the entire area other than the first sub-display area 2 and the second sub-display area 3. Further, as shown in FIG. 2, the main display area 1 comprises a first pixel unit. The first pixel unit comprises a first sub-pixel unit 7 and a first transparent subunit 6, the first sub-display area 2 and the second sub-display area 3 comprise a second pixel unit, and the second pixel unit comprises a second sub-pixel unit 7′ and a second transparent subunit 6′. The difference is that an area of the second transparent subunit 6′ is greater than an area of the first transparent subunit 6.

Specifically, the first sub-pixel unit 7 and the second sub-pixel unit 7′ consist of RGB, and the first transparent subunit 6 and the second transparent subunit 6′ may be hollow structures, that is, filter layers consisting of RGB are omitted, and a planarization layer, a protective layer, and an ITO conductive layer thereon are directly coated.

The embodiment divides a display screen into a main display screen and a sub-display screen which are correspondingly connected to a first display driver integrated circuit and a second display driver integrated circuit, thereby respectively controlling a main display area and a sub-display area to display images. That is, when functional components are in a normal working status, the second display driver integrated circuit is turned off, and images are not displayed in the sub-display area; when the functional components are in a non-working status, the second display driver integrated circuit controls the sub-display area to display normally, thereby achieving a full screen display, improving the screen ratio, and providing a better visual experience for users. Furthermore, making an area of a transparent area of the second pixel unit of the sub-display screen greater than an area of a transparent area of the first pixel unit of the main display screen improves transmittance and transparency of the sub-display area, thereby making the functional components work normally.

Preferably, the functional components disposed in the first sub-display area 2 comprise devices such as a camera, an infrared sensor, and a flash lamp.

Preferably, the functional components disposed in the second sub-display area 3 comprise devices such as a fingerprint sensor.

The present disclosure further provides a composite display screen module. The composite display screen module comprises: the above composite display screen; an input unit connected to a touch control sensor, and used to generate an image signal in response to a user's input operation; and an image processing unit connected to the input unit, and used to divide a received image signal into a first part and a second part, wherein the first part corresponds to the main display area 1, and the second part corresponds to the sub-display area 2, 3;

wherein the sub-display screen of the composite display screen is a first sub-display screen corresponding to a first sub-display area 2 and electrically connected to the second display driver integrated circuit 5, wherein the first sub-display area 2 is disposed on the upper part of the composite display screen.

Preferably, the composite display screen further comprises a second sub-display screen corresponding to a second sub-display area 3 and electrically connected to the second display driver integrated circuit 5, wherein the second sub-display area 3 is disposed on the lower part of the composite display screen.

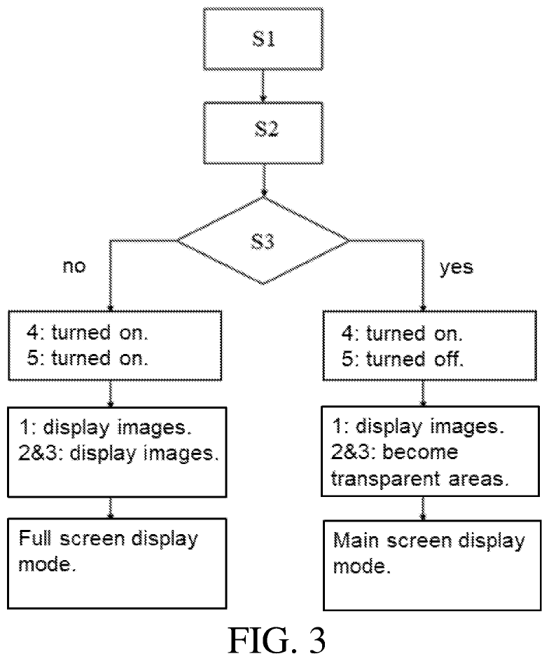

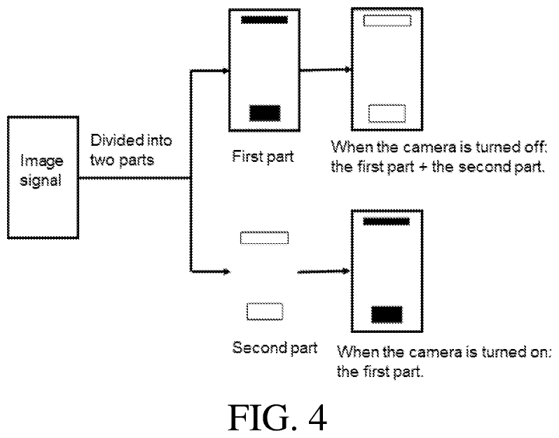

Referring to FIG. 3 and FIG. 4, FIG. 3 is an image processing flowchart of a display control method of a composite display screen module according to an embodiment of the present disclosure, and FIG. 4 is an image displaying flowchart of a display control method of a composite display screen module according to an embodiment of the present disclosure.

Further, an embodiment of the present disclosure provides a display control method of the above composite display screen module. The method comprises following steps:

S1) the input unit transmitting the image signal to the image processing unit. That is, the input unit generates a display operation signal and transmits to the image processing unit in response to a user's input operation.

S2) the image processing unit dividing the received image signal into the first part and the second part, wherein the first part corresponds to the main display area 1, and the second part corresponds to the first sub-display area 2 and the second sub-display area 3.

S3) the image processing unit detecting whether devices in the sub-display area are turned on. That is, determining if the devices, such as cameras, are in use.

S4) the image processing unit controlling the first display driver integrated circuit and the second display driver integrated circuit to modulate whether to display images in the main display area and the sub-display area.

Further, wherein the step S4) further comprises following steps: S5) if the devices in the sub-display area are detected to be turned on, the image processing unit will control the first display driver integrated circuit to be turned on and the second display driver integrated circuit to be turned off.

Further, wherein the step S5) further comprises following steps: S6) making the image signal of the first part displayed in the main display area and the image signal of the second part not displayed.

Further, wherein the step S4) further comprises following steps: S7) if the devices in the sub-display area are detected to be turned off, the image processing unit will control the first display driver integrated circuit and the second display driver integrated circuit to be turned on.

Further, wherein the step S7) further comprises following steps: S8) making the image signal of the first part displayed in the main display area and the image signal of the second part displayed in the sub-display area.

Specifically, when the devices in the first sub-display area 2 and the second sub-display area 3 are turned on, the first display driver integrated circuit 4 will be turned on, and the second display driver integrated circuit 5 will be turned off, thereby making the main display area 1 display the image signal of the first part and the first sub-display area 2 and the second sub-display area 3 become transparent areas, which forms a main screen display mode.

When the devices in the first sub-display area 2 and the second sub-display area 3 are turned off, the first display driver integrated circuit 4 and the second display driver integrated circuit 5 will be turned on, thereby making the main display area 1 display the image signal of the first part and the first sub-display area 2 and the second sub-display area 3 display the image signal of the second part, which forms a full screen display mode.

In summary, the present disclosure divides a display screen into a main display screen and a sub-display screen which are correspondingly connected to a first display driver integrated circuit and a second display driver integrated circuit, thereby controlling a main display area and a sub-display area to display images respectively. That is, the second display driver integrated circuit controls the images displayed or not displayed in the sub-display area according to a status of functional components, thereby achieving a full screen display, improving the screen ratio, and providing a better visual experience for users. Further, making an area of a transparent area of the second pixel unit of the sub-display screen greater than an area of a transparent area of the first pixel unit of the main display screen improves transmittance and transparency in the sub-display area, thereby making functional components work normally.

Although the present disclosure has been shown and described with respect to one or more embodiments, those skilled in the art will recognize equivalent variations and modifications upon reading and understanding the present specification and drawings. The present disclosure includes all such modifications and alterations, and is limited only by the scope of the appended claims. Moreover, the terms “including”, “having”, “containing”, or variations thereof are used in the detailed description or claims, such terms are intended to be included in a manner similar to the term “comprising”.

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A composite display screen, comprising:
a main display screen corresponding to a main display area and electrically connected to a first display driver integrated circuit; and
at least one sub-display screen corresponding to a sub-display area and electrically connected to a second display driver integrated circuit, wherein the sub-display area is disposed on an upper part or/and a lower part of the composite display screen, and a plurality of functional components are disposed correspondingly in the sub-display area.

2. The composite display screen according to claim 1, wherein a first pixel unit in the main display area comprises a first sub-pixel unit and a first transparent subunit, a second pixel unit of the sub-display screen comprises a second sub-pixel unit and a second transparent subunit, and an area of the second transparent subunit is greater than an area of the first transparent subunit.

3. The composite display screen according to claim 1, wherein the sub-display screen is a first sub-display screen corresponding to a first sub-display area and electrically connected to the second display driver integrated circuit, wherein the first sub-display area is disposed on the upper part of the composite display screen.

4. The composite display screen according to claim 3, comprising a second sub-display screen corresponding to a second sub-display area and electrically connected to the second display driver integrated circuit, wherein the second sub-display area is disposed on the lower part of the composite display screen.

5. The composite display screen according to claim 3, wherein the functional components disposed in the first sub-display area comprise a camera, an infrared sensor, or a flash lamp.

6. The composite display screen according to claim 4, wherein the functional components disposed in the second sub-display area comprise a fingerprint sensor.

7. A composite display screen module, comprising:
the composite display screen according to claim 1;
an input unit connected to a touch control sensor, and used to generate an image signal in response to a user's input operation; and
an image processing unit connected to the input unit, and used to divide a received image signal into a first part and a second part, wherein the first part corresponds to the main display area, and the second part corresponds to the sub-display area.

8. The composite display screen module according to claim 7, wherein a first pixel unit in the main display area comprises a first sub-pixel unit and a first transparent subunit, a second pixel unit of the sub-display screen comprises a second sub-pixel unit and a second transparent subunit, and an area of the second transparent subunit is greater than an area of the first transparent subunit.

9. The composite display screen module according to claim 8, wherein the sub-display screen of the composite display screen is a first sub-display screen corresponding to a first sub-display area and electrically connected to the second display driver integrated circuit, wherein the first sub-display area is disposed on the upper part of the composite display screen.

10. The composite display screen module according to claim 9, wherein the composite display screen comprises a second sub-display screen corresponding to a second sub-display area and electrically connected to the second display driver integrated circuit, wherein the second sub-display area is disposed on the lower part of the composite display screen.

11. A display control method of the composite display screen module according to claim 7, comprising following steps:
S1) the input unit transmitting the image signal to the image processing unit; and
S2) the image processing unit dividing the received image signal into the first part and the second part, wherein the first part corresponds to the main display area, and the second part corresponds to the sub-display area.

12. The display control method according to claim 11, comprising following steps:
S3) the image processing unit detecting whether devices in the sub-display area are turned on; and
S4) the image processing unit controlling the first display driver integrated circuit and the second display driver integrated circuit to modulate whether to display images in the main display area and the sub-display area.

13. The display control method according to claim 12, wherein the step S4) comprises following steps: S5) if the devices in the sub-display area are detected to be turned on, the image processing unit will control the first display driver integrated circuit to be turned on and the second display driver integrated circuit to be turned off.

14. The display control method according to claim 13, wherein the step S5) comprises following steps: S6) making the image signal of the first part displayed in the main display area and the image signal of the second part not displayed.

15. The display control method according to claim 12, wherein the step S4) comprises following steps: S7) if the devices in the sub-display area are detected to be turned off, the image processing unit will control the first display driver integrated circuit and the second display driver integrated circuit to be turned on.

16. The display control method according to claim 15, wherein the step S7) comprises following steps: S8) making the image signal of the first part displayed in the main display area and the image signal of the second part displayed in the sub-display area.
